(19) United States
(12) Patent Application Publication
(10) Pub. No.: US 2019/0080397 A1
(43) Pub. Date: Mar. 14, 2019

(54) EXPERT SYSTEM FOR EXTRACTING TARGET DATA AND INFERRING TARGET VARIABLE VALUES

(71) Applicant: FANNIE MAE, Washington, DC (US)

(72) Inventors: David Monaco, Bethesda, MD (US); Hannah Marlowe, Alexandria, VA (US); Stacey Shifman, Rockville, MD (US); James Gottlieb, Reston, VA (US); Eric Rosenblatt, Derwood, MD (US)

(21) Appl. No.: 15/700,908

(22) Filed: Sep. 11, 2017

(51) Int. Cl. G06Q 40/02

(52) U.S. Cl. CPC G06Q 40/025

(57) ABSTRACT

An expert system for extracting data found within heterogeneous data sets and making corresponding inferences in order to infer target variable values is disclosed. In one example, the expert system breaks down electronic datasets of asset accounts and analyzes them to extract relevant variables and perform corresponding verification and validation. The expert system may, for example, be configured determine if direct deposit of salary is evidence of sufficient gross income to meet debt to income requirements in a loan application process.

### BACKGROUND OF THE INVENTION

### 1. Field of the Invention

This application relates to extracting data found within heterogeneous data sets and making corresponding inferences in order to infer target variable values.

### 2. Description of the Related Art

There remains a need for expert systems that can access heterogeneous datasets, extract desired information, and make corresponding inferences for various purposes.

For example, when applying for mortgages, borrowers must demonstrate specific values of “gross” income. This income information is used to compute debt to income ratios (DTI) in accordance with rules typically set forth by governing agencies, required by lenders and/or guarantors, and relied upon for valuation (e.g., for bond holders of mortgage backed securities who use the DTI in models that predict the duration (through borrower prepayment speeds) of securities). For example, a common mortgage eligibility cut-off is 45% DTI, though various mortgage products can have different cut-offs. Mortgage lenders must often validate the incomes of mortgage applicants, and must at times be prepared to repurchase any loans and make whole all losses on those loans if their validation is faulty. This creates a potential liability for the lenders, who make documentation demands of borrowers that are often experienced as burdensome by mortgage applicants who cannot locate and deliver the necessary documentation.

At the same time, electronic data is available regarding borrower accounts, albeit in a form that does not support ready determination of income.

What is needed is an expert system that is able to access data that may include income information, extract the income information from the accessed data, and make inferences to refine the data so that it represents an accurate and reliable example of the desired income variable.

### SUMMARY OF THE INVENTION

According to one aspect of this disclosure, an expert system breaks down electronic datasets of asset accounts and analyzes them to extract relevant variables and perform corresponding verification and validation.

In one example, the expert system is configured determine if direct deposit of salary is evidence of sufficient gross income to meet DTI requirements (e.g., of guarantors), who can then automatically grant relief from income validation requirements of lenders. Since the guarantors must satisfy various federal regulatory agencies, accounting regulations, mortgage insurance holders that reinsure mortgages, and bond holders, they must demonstrate particular accuracy in the assessment of asset account cash flows. The expert system automates the validation and verification of income and other variables underlying these assessments.

The present invention can be embodied in various forms, including business processes, computer implemented methods, computer program products, computer systems and networks, user interfaces, application programming interfaces, and the like.

### BRIEF DESCRIPTION OF THE DRAWINGS

These and other more detailed and specific features of the present invention are more fully disclosed in the following specification, reference being had to the accompanying drawings, in which:

FIG. 1 is a schematic diagram illustrating a system that includes an underwriting assistance application with an expert system for income identification and verification;

FIG. 2 is a flow diagram illustrating an example of a process for extracting income data and determining income variables;

FIG. 3 is a block diagram illustrating an example of an expert system for extracting income data and determining income variables;

FIG. 4 is a display diagram illustrating an example of an income information panel set to display an unfiltered transaction stream; and

FIG. 5 is a display diagram illustrating an example of an income information panel set to display income entries.

FIG. 6 is a flow diagram illustrating an example of a process for determining loan eligibility that implements a comparison of submitted income information to extracted and determined income variables.

FIG. 7 is a logic flow diagram illustrating a logic flow for determining base and bonus information.

### DETAILED DESCRIPTION OF THE INVENTION

In the following description, for purposes of explanation, numerous details are set forth, such as flowcharts and system configurations, in order to provide an understanding of one or more embodiments of the present invention. However, it is and will be apparent to one skilled in the art that these specific details are not required in order to practice the present invention.

According to one aspect of this disclosure, an expert system is configured determine if direct deposit of salary is evidence of sufficient gross income to meet DTI requirements (e.g., of guarantors), who can then automatically grant relief from income validation requirements of lenders. Since the guarantors must satisfy various Federal regulatory agencies, accounting regulations, mortgage insurance holders that reinsure mortgages, and bond holders, they must demonstrate particular accuracy in the assessment of asset account cash flows. The expert system breaks down electronic datasets of asset accounts and analyzes them through a variety of steps in order to extract relevant variables, and refine the variables as necessary, and to calculate the sufficiency of variables, including but not necessarily limited to income, in order to support immediate validation of the same.

In addition to salary income, the system is configured to extract and determine Social Security Income, Supplemental Security Income, VA Disability Income, and Pension income (e.g., where pension is defined by strings observed in the description part of the deposit, and matched to a dictionary of strings that is maintained and periodically supplemented).

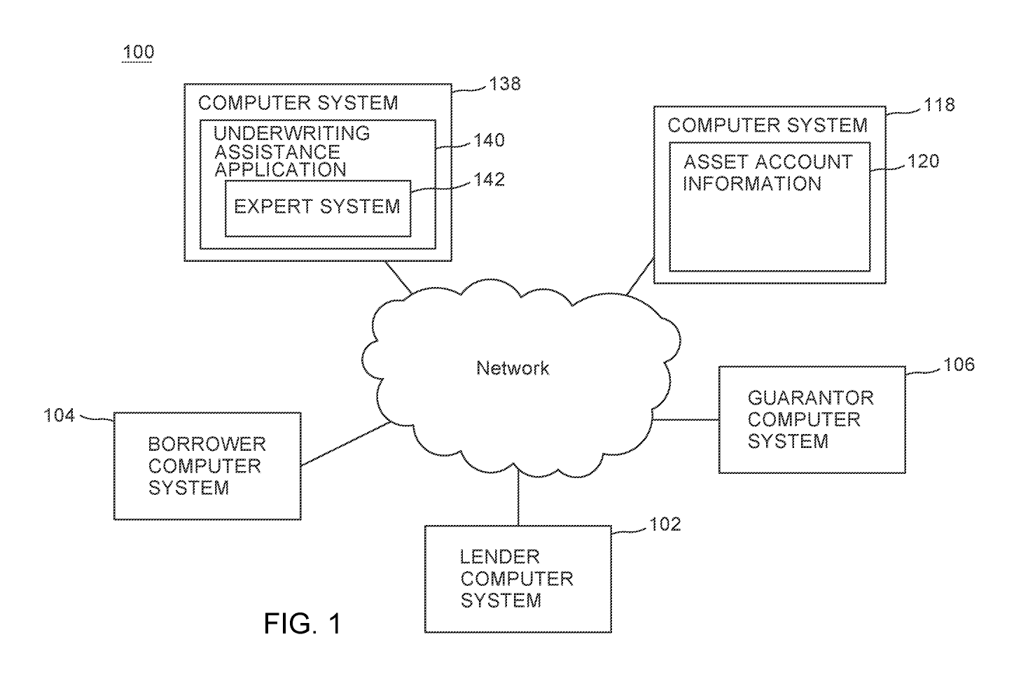

FIG. 1 illustrates a system 100 wherein an underwriting assistance application 140 is variously accessed by a lender computer system 102 and guarantor computer system 106 in connection with a mortgage loan application. A borrower may also use a borrower computer system 104 to communicate with the lender computer system 102 (or may otherwise communicate with the lender) to provide mortgage loan application information to the lender. This information includes name and identification information, account information, income information, debt information, and other information supportive of the application for the underlying loan.

The underwriting assistance application 140 executes on a computer system 138 and is configured to assist the lender in assessing and validating the information for the borrower that is presented in the application. The underwriting assistance application 140 executes on any conventional computing platform, and is accessible by parties including the lender (via the lender computing system 102), such as through secure communications over an Internet connection. The underwriting assistance application 140 is configured to report and display borrower information and related criteria such as the borrower's housing expense ratio, debt-to-income ratio, and FICO scores. To do this, the underwriting assistance application accesses one or more external resources such as the illustrated asset account information 120. The asset account information 120 is provided via a computer system 118, typically as hosted or provided by a service provider of the asset account information. By way of example, the asset account information may be information provided by credit reporting agencies such as Equifax, and/or compiled asset information such as that provided by FormFree LLC.

The underwriting assistance application 140 may also receive and display a borrower's assets (source of funds to buy) and liabilities as reported to the lender. Liabilities may also include external information, such as revolving debt reported to the credit reporting agencies. The information includes borrower name, approximate unpaid balances of obligations, minimum monthly payments and the like.

In one example, the basic configuration of the underwriting assistance application 140 may be that of DesktopUnderwriter (DU) as provided by Fannie Mae (Washington, D.C.).

In accordance with one example of this disclosure, the underwriting assistance application 140 is further configured to include an expert system 142 for income identification and verification, which accesses the above-described reported asset and liability information, accesses at least one heterogeneous dataset corresponding to one or more borrower accounts, extracts income information from the dataset, and determines income variables such as gross income and corresponding DTI. The asset account information 120 is accessible in connection with the loan application of a given borrower. The asset account information 120 includes a variety of entries related to deposits, withdrawals and the like. The expert system 142 is configured to extract those entries that are examples of income, and to make refinements as necessary to calculate a useable metric such as gross income, and from that the DTI.

The expert system 142 is preferably provided as software executable on a computing platform, although it may be provided as hardware, or combinations of software and hardware. The software may be stored on any conventional non-transitory computer readable medium, including but not limited to hard drives, optical storage media, solid state memory or dynamic memory. Although the computing platform may be conventional, the expert system 142 is distinct from and improves upon any conventional computing system in its provision of mechanisms for automatically extracting income information as described herein.

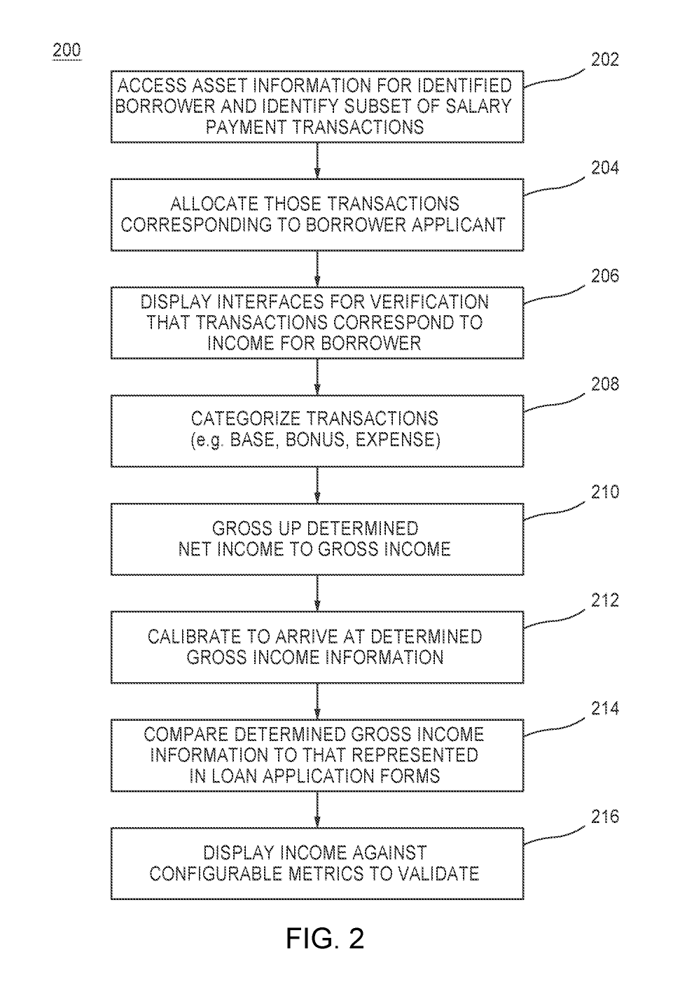

FIG. 2 is a flow diagram illustrating an example of a process 200 for extracting income information from a heterogeneous dataset, such as performed by the expert system (142).

The system initially accesses asset information and identifies 202 a subset of transactions as salary payment transactions. Here, the system must establish that some subset (e.g., sometimes hundreds) of transactions per month are salary payments. The system accesses the dates corresponding to each transaction, as well as language in the attendant “advice” of each payment. In general, payments on the following demonstrable cycles are considered likely to be salaries: weekly, biweekly, monthly, semi-monthly. Transactions having similar description fields are grouped into representative incomes streams. The system fits known pay patterns (weekly, biweekly, semimonthly, monthly) to each income stream to determine the pay frequency. Using the best fit pay pattern for each income stream, all component transactions are marked as on-date (they fall on an expected pay date based on the preceding and subsequent transactions) or off-date. A stream is required to have a minimum number of on-date transactions and total length of history for the determined pay schedule to be considered further. Pay streams that meet minimum history and regularity requirements may still be excluded based on description keywords in a global exclusion dictionary (e.g., the term “transfer” may trigger an exclusion).

Once the subset of transactions that are salary payments is accumulated, the system allocates 204 the income to a particular applicant. Where the account is for an individual, this step is straightforward in that it is presumably all entries. However, many accounts are joint accounts. Accordingly, this step entails the application of rules to correlate income entries to the actual borrower/applicant in question. The system utilizes matching logic to compare applicant and reported employer names to the description field of the transactions in each income stream. The quality of the match determines whether a stream can be allocated to a particular applicant's reported income. For instance, the optimal match occurs when the description contains a (‘fuzzy’) employer name and an applicant's unique full first and last name. Less optimal matches impose restrictions on which and how many streams may be kept for each reported income source.

In conjunction with this, the system also displays 206 interfaces for verification that the identified transactions correspond to borrower income. Essentially, the system allows the user to observe and consider the entries that have been made into the loan origination system where the borrowers detail their employers and income categories.

The system also categorizes 208 whether payments are base, bonus, expense, or other. This implements an algorithm that determines patterns of payments and exceptions to regular patterns.

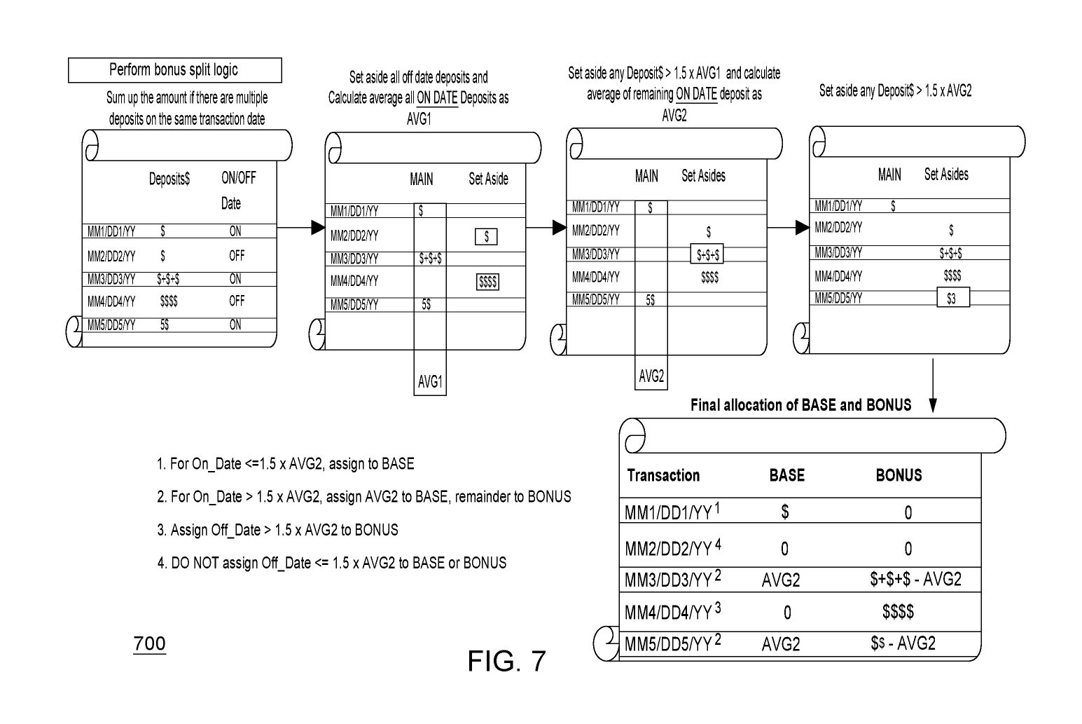

FIG. 7 illustrates the logic flow 700 for determining base and bonus payments. The system determines whether the income payments constitute wage income (base, bonus, overtime, and commission) or other forms of income including Social Security, Retirement and Pension, and VA benefits. Wage income is identified by the regular pay pattern combined applicant's name and/or employer name match. Other forms of income are identified by an additional constraint that the transactions must contain known keywords (e.g., “SSA TREAS” for social security income). These keywords are maintained in dictionaries for each income type.

For wage income, the base pay rate and bonus allocation are determined through a multi-pass analysis of all transactions in the pay stream. First, an average is taken of all on-date transactions. Anything above 150% of this average is set aside. A second average is taken, and again any remaining transactions that are above 150% of the second average are also set aside. Deposits that are off-date and above 150% of the second average are allocated to bonus, while lower amount off-date deposits are discarded. On-date deposits that are 150% of the second average are split between base and bonus by allocating the second average amount to base and remaining amount to bonus. The base pay rate is taken as a final average of base allocated deposits and the bonus is capped to be at most 25% of the base pay rate.

Still referring to FIG. 2, the system next performs a gross up process 210 that retrieves and then grosses up the net direct payment up according to amount, state, and number of borrowers. The raw gross up amount is then calibrated 212 to arrive at determined gross income information. The calibration may be variously configured according to institutional requirements.

Once the gross income information is fully obtained and refined according to the above, a comparison 214 between the determined gross income information and that represented by the borrower in the loan application process is made. This is done by examining and summing any and all differently supported assertions of income and comparing them to the grossed-up amounts verified from the accessed data. For example, the system sums up differently supported assertions of income from the 1003 form of the Desktop Underwriter system, where Desktop Underwriter is implemented. Alternative systems may use alternative forms to collect the same information.

Finally, the system is configurable to display and validate 216 the income. For example, this may include determination of how often the gross up of summed validated income exceeds what is a probable and acceptable record of income. This aspect may be configurable according to requirements of the lender and/or guarantor. For example, it may be determined that anything within two percent overage is acceptable.

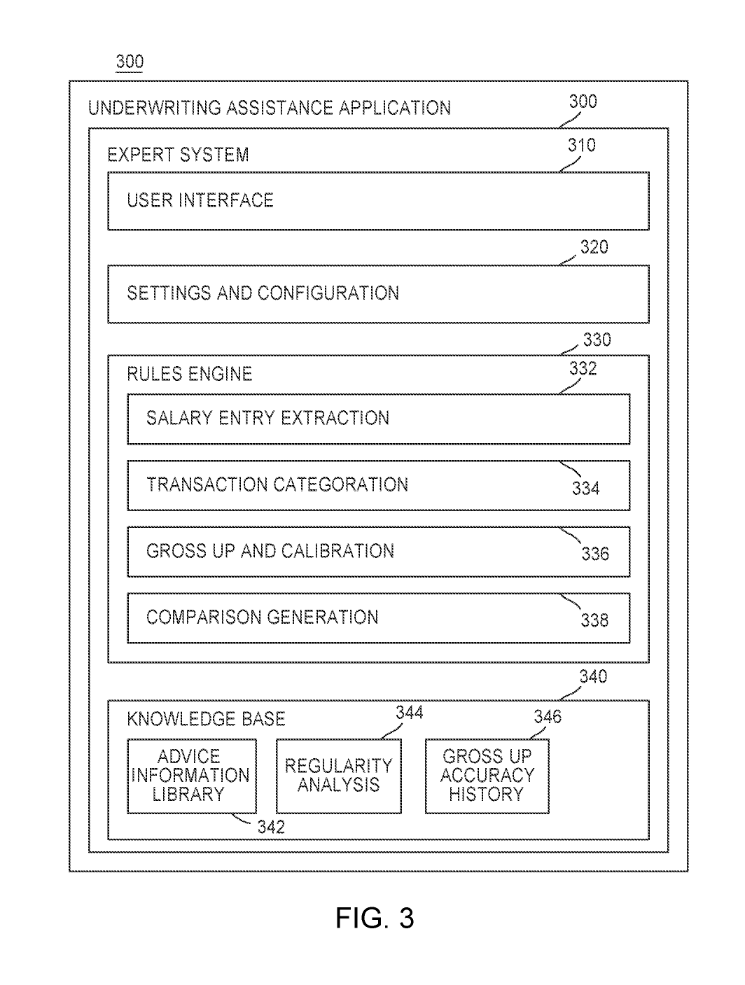

FIG. 3 is a block diagram illustrating an example of an expert system 300 for extracting income data and determining income variables in further detail.

The expert system 300 includes user interface 310, settings and configurations 320, rules engine 330 and knowledge base 340 components. The expert system 300 is preferably provided as software that executes on a computing platform, but may alternatively be provided as hardware or firmware, or any combination of software, hardware and firmware. The expert system 300 is configured to provide the functionality described above in connection with FIG. 2 and as further described below.

The user interface 310 component is configured to provide the user interfaces displayed by the underwriting assistance information in connection with the display of underwriting information, and in particular income and related information in connection with the analysis of borrower income streams. The user interfaces are also configured to receive various input to allow user entry of information and to allow the user to navigation among a variety of information screens as described further below.

The settings and configurations 320 component stores basic settings information including user identification and registration information. Configurable settings are also maintained corresponding to each user account. The settings and configurations 320 component 320 also stores configurable settings used to access and extract income entries from raw asset information transaction data from a variety of asset information resources. These settings also correlate to user accounts to ensure appropriate and secure access to asset information accounts for any given user/lender/borrower/guarantor depending upon the circumstances of any given inquiry.

The rules engine 330 component includes salary entry extraction 332, transaction categorization 334, gross up/calibration 336 and comparison generation 338 components. The rules engine 330 component engages with and supports the updating of a corresponding knowledge base 340 component. The knowledge base 340 component maintains and updates knowledge in a variety of categories. It includes, for example, advice information library 342, regularity analysis 344 and gross up accuracy history 346 components.

The expert system 300 accesses asset information corresponding to one or more borrowers. That information includes raw transaction data corresponding to one or more borrower accounts. This raw transaction data may include a variety of entries including ad hoc deposits by the borrower, interest allocations, regular salary advices, bonus salary advices, debits, and any number of entries, which may number into hundreds or thousands for any given borrower. Additionally, the account may be in some cases an individual account of a borrower, or may be a joint account or other type of account that involves another individual, and as such there may be transactions that do not directly involve the borrower.

The salary entry extraction 332 component, in conjunction with the advice information library 342 and regularity analysis 344 components, carries out algorithms for parsing the raw transaction data to determine an initial set of entries deemed to be particular to income for the borrower under analysis. The advice information library 342 includes a database of financial and other institution information that includes entries identifying how advice transactions in raw transaction data may be abbreviated, truncated or otherwise represented among the raw transaction data. The advice information library 342 is built and refined over time to accurately reflect acceptable examples of how the advice transactions may be represented. Confidence metrics may be used in connection with determining whether to conclude any given transaction to be a salary transaction, and post analysis audits may be used to grow or refine the library for any given instruction. The salary entry extraction 332 component also includes program code to execute algorithms for determining whether entries in the raw transaction data are salary transactions. Regularity analysis is among the criteria for making such determinations. Under default conditions, any regularity of weekly, biweekly, monthly, and/or semi-monthly may be applied to entries to gauge whether they are salary transactions. First, a determination is made as to whether there are repeated amounts within the raw transaction data that match within a predetermined tolerance range. Then, date analysis is conducted to determine whether there is sufficient regularity among such repeated amounts to warrant a conclusion that they represent salary transactions. The regularity analysis 344 component may be accessed and updated for and in conjunction with these determinations. For example, the regularity analysis 344 component may correlate acceptable salary periods to corresponding employer institutions. The advice information library 342 also retains and updates entries for employers (e.g., corresponding truncations and abbreviations) to assist in the identification of transactions as salary transactions.

The transaction categorization 334 component categorizes entries as base, bonus, expense or other, using the algorithm and logic flow described in connection with FIG. 2 and FIG. 7 above. The knowledge base 340 may also be updated in connection with categorization information.

The gross up and calibration 336 component includes program code for determining a grossed up amount corresponding to the salary information. For example, once base salary transaction amounts are identified, they are presumably net transactions following deductions for federal and state tax withholding, among other things. However, since the primary metric for income in the loan application process, DTI, uses gross income, the income transactions must be adjusted accordingly. The gross up and calibration 336 component accesses a variety of predetermined information such as federal and state tax rates and exemption information, as well as customizable variable data, such as amounts the employer may typically deduct for benefits or other reasons, in order to determine an initial grossed up salary amount for the borrower. The gross up accuracy history 346 includes not only the basic information used to determine gross up information, but also builds data corresponding to the accuracy of the assumptions used to determine the gross up information. Over time, this allows refinement of the assumptions and variables used to calculate the gross up information.

The initial grossed up salary amount is also calibrated in support of final comparisons. The calibration of the initial amount is customizable.

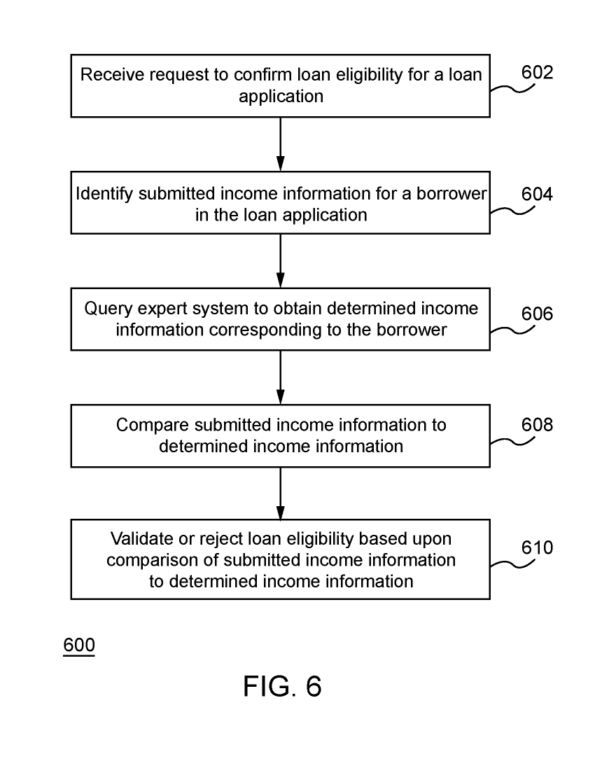

Finally, the comparison generation 338 component includes program code supportive of side-by-side comparison of the calibrated salary amount to the information provided by the borrower during the loan application process (e.g., the representations about salary made in loan application forms). The user interfaces are generated accordingly, with entries corresponding to the provided information and the calibrated salary amount. The expert system 300 is further configurable to make follow on calculations and to indicate and update loan application eligibility in connection with the extracted and refined salary information as compared to what was represented in the application. (See, e.g., FIG. 6).

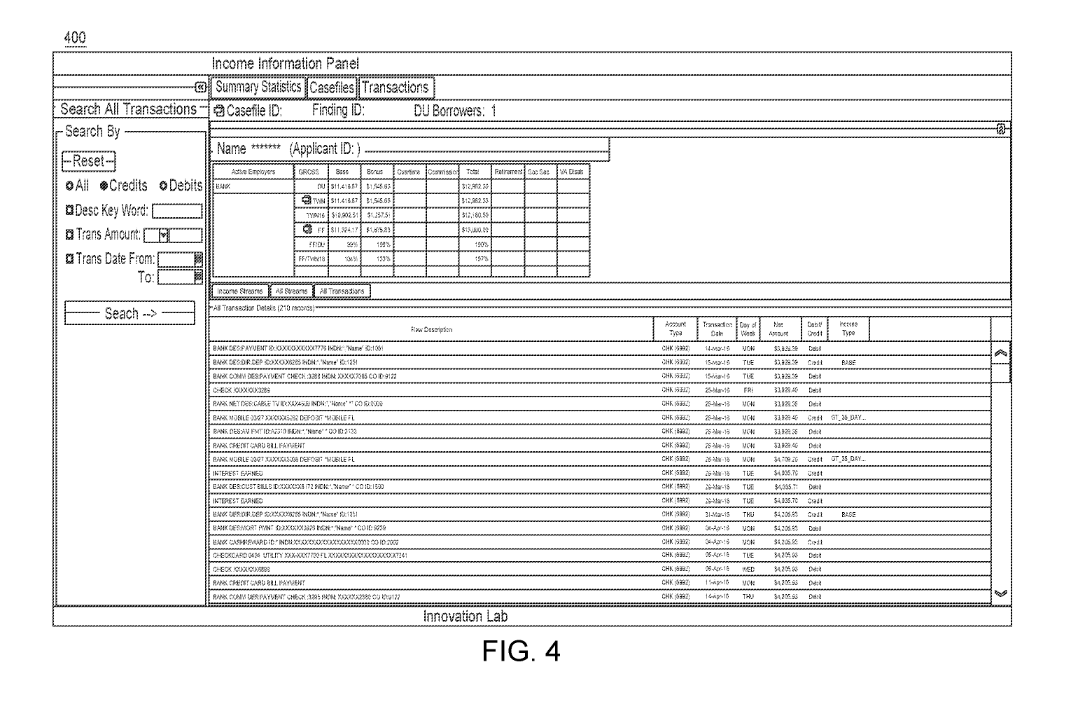

FIG. 4 is a display diagram illustrating an example of an income information panel 400 set to display an unfiltered transaction stream. The income information panel 400 includes sections that identify the loan applicant and provide a corresponding overview of the determined salary information, broken down into base, bonus and overtime categories as shown. Additionally, the submitted salary information under the loan application is illustrated.

Underneath the loan applicant section, there is a transaction data section that includes entries corresponding to transactions, with columns designated as raw description, account type, date, amount, debit/credit, and income type columns. A tab function allows the section to be updated so as to include “all transactions”, “all streams” and “income streams”. Here, all transactions are shown, so the entries include various items other than what the expert system has identified as income.

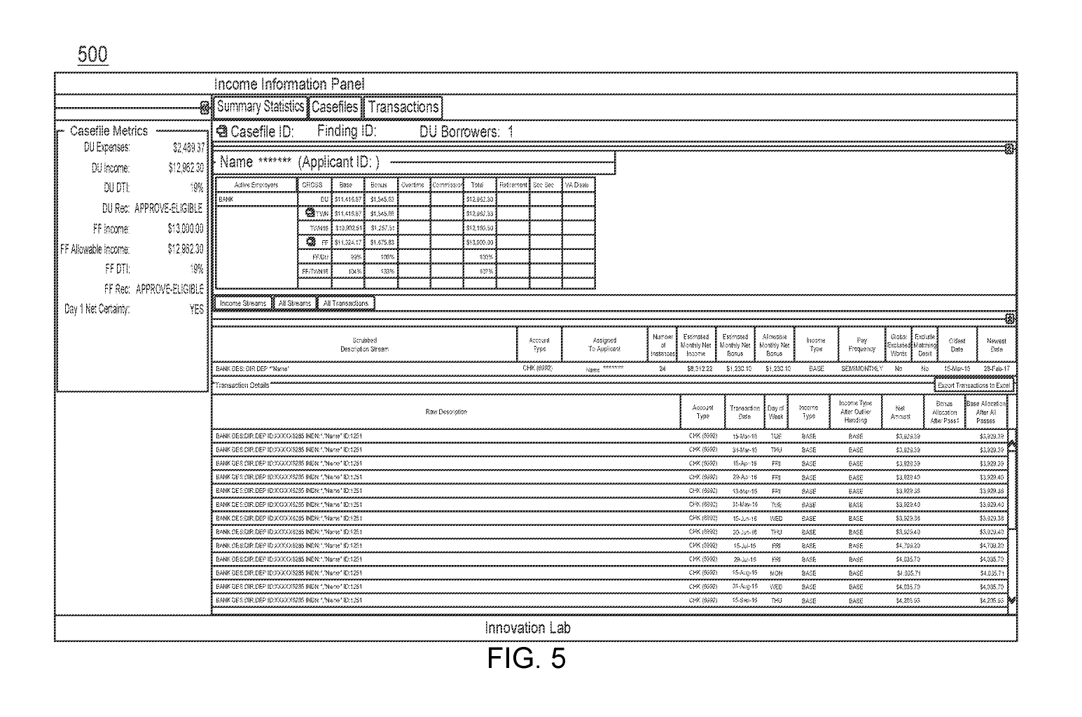

FIG. 5 is a display diagram illustrating an example of an income information panel 500 set to display income entries. Here, the transaction data section is updated to reflect its state when the income streams tab is engaged. As indicated, the income type field is populated for each entry, since the illustrated entries are limited to income entries. Although only base income entries are illustrated, others such as bonus are also illustrated depending upon the findings of the expert system for any given applicant. In addition to the same columns corresponding to each entry in the transaction data, an overview of the income information is provided, including identification of the estimated monthly net income and bonus, pay frequency, and other information. Thus, the loan application section and the transaction data section update automatically and are concurrently displayed, in a fashion that provides an efficient overview of the income situation for the loan applicant in question.

FIG. 6 is a flow diagram illustrating an example of a process 600 for determining loan eligibility that implements a comparison of submitted income information to extracted and determined income variables, such as performed by the underwriting assistance application (FIG. 1, 140).

The process initially entails receiving 602 a request to confirm loan eligibility for a loan application. In a typical scenario, a borrower meets with a lender and provides information in connection with a loan application. The loan application also includes criteria such as a loan amount, etc. The information provided by the borrower includes borrower identification information as well as income information. This information, provided by the borrower and input to the underwriting assistance application, is referred to as submitted income information. The process 600 for determining lean eligibility continues by identifying 604 this submitted income information for the borrower in connection with the loan application.

The expert system is then invoked in order to obtain 606 determined income information corresponding to the borrower. The determined income information is generated by the expert system according to the processes described above, wherein income information is extracted from raw transaction date and is then processed to ultimately result in determined income information by the expert system. Typically, the submitted information and the determined information are gross income for the borrower.

The underwriting assistance application then compares 608 the submitted income information to the determined income information, and then validates 610 or indicates rejection of loan eligibility based upon comparison of the submitted income information (that provided by the borrower in the loan application) to the determined income information (that extracted and processed by the expert system).

Thus embodiments of the present disclosure produce and provide methods and apparatus for automatically extracting income information and inferring corresponding income information variables, such as in support of a loan application process. Although the present disclosure has been described in considerable detail with reference to certain embodiments thereof, the invention may be variously embodied without departing from the spirit or scope of the invention. Therefore, the following claims should not be limited to the description of the embodiments contained herein in any way.

1. A method for extracting and validating income amounts from raw transaction data, the method comprising:
accessing the raw transaction data and identifying a subset of transactions as income transactions;
verifying that the income transactions are for a borrower in a loan application and determining a net income amount corresponding to the verified income transactions;
performing a gross up process on the net income amount to produce a preliminary gross up amount; and
calibrating the preliminary gross up amount to produce a determined income amount.

2. The method of claim 1, further comprising:
displaying interfaces for the verification that the income transactions correspond to the borrower income.

3. The method of claim 1, further comprising:
categorizing respective entries in the subset of transactions according to income categories, wherein the income categories comprise base and bonus categories.

4. The method of claim 1, further comprising:
displaying an interface comparing the determined income amount to a provided income amount, wherein the provided income amount is a borrower representation made in the loan application.

5. The method of claim 1, further comprising:
displaying an indication of a frequency of the determined income amount exceeding a predetermined threshold amount.

6. The method of claim 1, further comprising:
comparing the determined income amount to a submitted income amount corresponding to a loan application; and
validating the submitted income amount based upon the comparison.

7. A non-transitory computer readable medium storing program code for extracting and validating income amounts from raw transaction data, the program code being executable by a processor to perform operations comprising:
accessing the raw transaction data and identifying a subset of transactions as income transactions;
verifying that the income transactions are for a borrower in a loan application and determining a net income amount corresponding to the verified income transactions;
performing a gross up process on the net income amount to produce a preliminary gross up amount; and
calibrating the preliminary gross up amount to produce a determined income amount.

8. The computer readable medium of claim 7, wherein the operations further comprise:
displaying interfaces for the verification that the income transactions correspond to the borrower income.

9. The computer readable medium of claim 7, wherein the operations further comprise:
categorizing respective entries in the subset of transactions according to income categories, wherein the income categories comprise base and bonus categories.

10. The computer readable medium of claim 7, wherein the operations further comprise:
displaying an interface comparing the determined income amount to a provided income amount, wherein the provided income amount is a borrower representation made in the loan application.

11. The computer readable medium of claim 7, wherein the operations further comprise:
displaying an indication of a frequency of the determined income amount exceeding a predetermined threshold amount.

12. The computer readable medium of claim 7, wherein the operations further comprise:
comparing the determined income amount to a submitted income amount corresponding to a loan application; and
validating the submitted income amount based upon the comparison.
